(19) United States
(12) Patent Application Publication
(10) Pub. No.: US 2015/0074492 A1
(43) Pub. Date: Mar. 12, 2015

(54) MEMORY SYSTEM AND MEMORY CONTROLLER

(71) Applicant: Kabushiki Kaisha Toshiba, Minato-ku (JP)

(72) Inventor: Atsuo SHONO, Yokohama-shi (JP)

(73) Assignee: Kabushiki Kaisha Toshiba, Minato-ku (JP)

(21) Appl. No.: 14/206,181

(22) Filed: Mar. 12, 2014

Related U.S. Application Data
(60) Provisional application No. 61/876,410, filed on Sep. 11, 2013.

(51) Int. Cl. G06F 11/10

(52) U.S. Cl. CPC G06F 11/1068
USPC 714/764

(57) ABSTRACT

According to one embodiment, a memory system includes nonvolatile memory, and a memory controller. The nonvolatile memory includes a plurality of blocks, each including a plurality of pages. The memory controller controls the nonvolatile memory. Here, the memory controller detects a first page of which a required minimum shift amount of a read voltage is largest for each block by reading data stored respectively in the plurality of pages while performing error detection. Further, the memory controller detects a second page of which the required minimum shift amount of a read voltage is larger than a predetermined first threshold by reading data stored in the first page of each of the blocks while shifting the read voltage in a first range, and performing error detection. Further, the memory controller refreshes data stored in the block having the second page.

### CROSS-REFERENCE TO RELATED APPLICATIONS

This application is based upon and claims the benefit of priority from U.S. Provisional Patent Application No. 61/876,410, filed on Sep. 11, 2013; the entire contents of which are incorporated herein by reference.

### FIELD

Embodiments described herein relate generally to a memory system and a memory controller.

### BACKGROUND

NAND type flash memory includes memory cells that can charge electrons in their floating gate electrodes. In the memory cell, a threshold voltage changes according to a number of electrons charged in the floating gate electrode, and data is stored therein in accordance with a difference of the threshold voltage. Upon reading, the threshold voltage is converted to a data value by the threshold voltage of the memory cell being compared with a predetermined voltage (read voltage). In recent years, as a size of the memory cells shrinks, the number of electrons charged in the floating gate electrode is being decreased. Due to this, an influence of interference noise between adjacent cells increases relatively. That is, by writing (programming) or reading being performed on one of the memory cells, there is a possibility that data in the other memory cell that is adjacent is changed. Thus, the read voltage may be shifted from an original read voltage, or data of which error bit rate exceeded a predetermined amount may be refreshed.

### BRIEF DESCRIPTION OF THE DRAWINGS

FIG. 1 is a diagram illustrating a configurational example of a memory system of a first embodiment of the invention.

FIG. 2 is a diagram illustrating a configurational example of a memory chip.

FIG. 3 is a diagram illustrating functional elements provided in a memory controller.

FIG. 4 is a diagram for describing pages to be read by a first detection patrol.

FIG. 5 is a diagram for describing pages to be read by a second detection patrol.

FIG. 6 is a diagram for describing pages to be read by a shift adjustment patrol.

FIG. 7 is a diagram for describing pages to be read by a refresh patrol.

FIG. 8 is a diagram for describing an execution schedule of the patrols.

FIG. 9 is a flow chart describing unit processing of the first detection patrol.

FIG. 10 is a flow chart describing unit processing of the second detection patrol.

FIG. 11 is a flow chart describing unit processing of the refresh patrol.

FIG. 12 is a flow chart describing unit processing of the shift adjustment patrol.

FIG. 13 is a diagram for describing pages to be read by a second detection patrol of a second embodiment.

FIG. 14 is a flow chart describing unit processing of the second detection patrol of the second embodiment.

### DETAILED DESCRIPTION

In general, according to one embodiment, a memory system includes nonvolatile memory, and a memory controller. The nonvolatile memory includes a plurality of blocks, each including a plurality of pages. The memory controller controls the nonvolatile memory. Here, the memory controller detects a first page of which a required minimum shift amount of a read voltage is largest for each block by reading data stored respectively in the plurality of pages while performing error detection. Further, the memory controller detects a second page of which the required minimum shift amount of a read voltage is larger than a predetermined first threshold by reading data stored in the first page of each of the blocks while shifting the read voltage in a first range, and performing error detection. Further, the memory controller refreshes data stored in the block having the second page. Exemplary embodiments of a memory system and a memory controller will be explained below in detail with reference to the accompanying drawings. The present invention is not limited to the following embodiments.

### First Embodiment

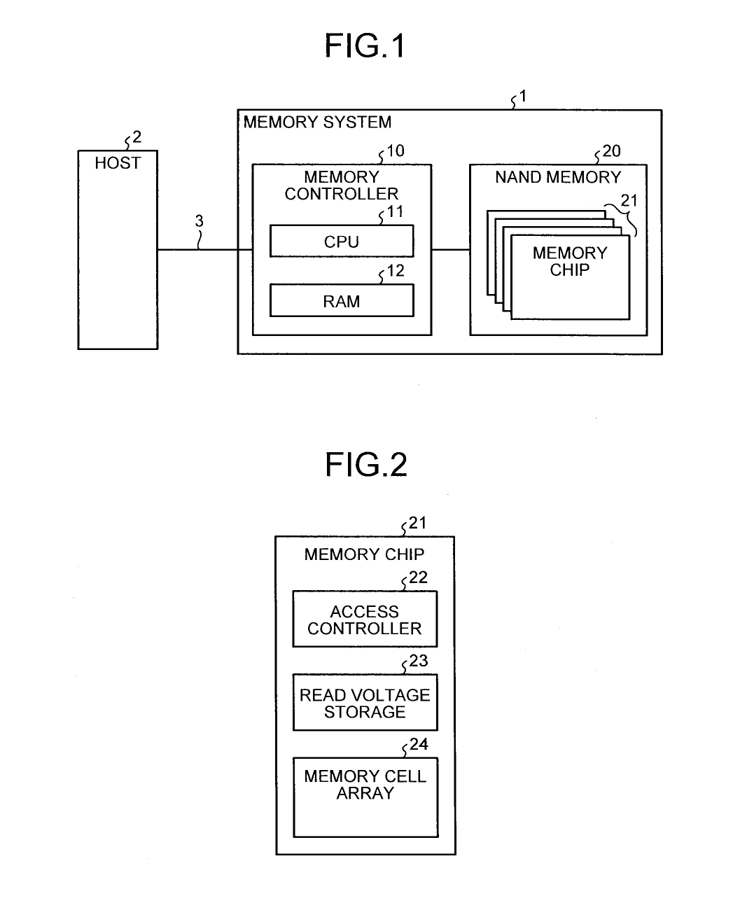

FIG. 1 is a diagram illustrating a configurational example of a memory system of the first embodiment of the invention. A memory system 1 is connected to a host 2 via a communication path 3. The host 2 is for example a computer. The computer includes a personal computer, a portable computer, a portable communication device and the like. The memory system 1 functions as an external storage device of the host 2. An interface standard of the communication path 3 is voluntary. The host 2 can send a write command and a read command to the memory system 1.

The memory system 1 includes a memory controller 10, and NAND type flash memory (NAND memory) 20 used as a storage. The memory controller 10 performs data transfer between the host 2 and the NAND memory 20 according to commands from the host 2. The memory controller 10 can perform internal processes such as compaction and wear levelling. The memory controller 10 issues various commands to the NAND memory 20 according to the commands from the host 2 or the internal processes. Hereafter, unless specifically described otherwise, a command means a command that is to be issued from the memory controller 10 to the NAND memory 20.

Notably, a type of the memory used as the storage is not limited to the NAND type flash memory. For example, NOR type flash memory, ReRAM (resistance random access memory), or MRAM (magnetoresistive random access memory) and the like may be employed.

The NAND memory 20 is configured of one or more memory chips 21.

FIG. 2 is a diagram illustrating a configurational example of a memory chip 21. The memory chips 21 each include an access controller 22, a read voltage storage 23, and a memory cell array 24. The memory cell array 24 is configured by a plurality of memory cells being arranged in a matrix. The memory cell array 24 is configured by arranging a plurality of blocks being units of Erase. Each block is configured by including a plurality of pages being units of Read and Program. The read voltage storage 23 stores an initial value of a read voltage. The initial value may differ in predetermined units (for example, for each block). The access controller 22 accesses the memory cell array 24 according to a command from the memory controller 10. The access includes programming, reading, and erasing. Programming is a process of injecting electrons to a floating gate electrode until a threshold voltage of a memory cell reaches a predetermined level corresponding to a data value. Erasing is a process of taking out the electrons from the floating gate electrode until the threshold voltage becomes less than a predeterminedly set erase voltage. Reading is a process of converting the threshold voltage to a data value by comparing the threshold voltage and the read voltage.

The memory controller 10 includes a CPU 11 and RAM 12. Respective functional elements of the memory controller 10 are realized by the CPU 11 executing firmware program. The RAM 12 is used as a region for the CPU 11 to execute the firmware program, a region where transfer data between the host 2 and the NAND memory 20 is buffered, and a region where various types of meta information are decompressed. The meta information includes translation information that records a corresponding relationship of a logical address designated by the host 2 and a physical address in a storage region that the NAND memory 20 configures, for example.

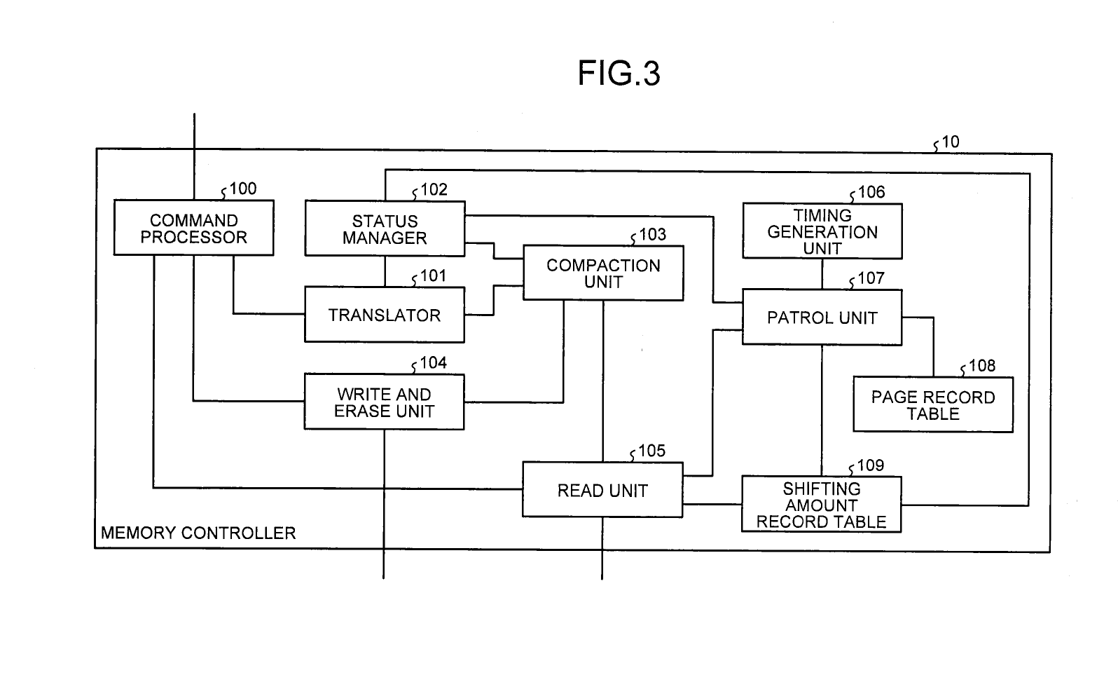

FIG. 3 is a diagram illustrating the functional elements provided in the memory controller 10. The memory controller 10 includes a command processor 100, a translator 101, a status manager 102, a compaction unit 103, a write and erase unit 104, a read unit 105, a timing generation unit 106, a patrol unit 107, a page record table 108, and a shift amount record table 109. The command processor 100, the translator 101, the status manager 102, the compaction unit 103, the write and erase unit 104, the read unit 105, the timing generation unit 106, and the patrol unit 107 are realized by the CPU 11 executing the firmware program. The page record table 108 and the shift amount record table 109 are stored for example in the RAM 12.

Notably, some of or all of the command processor 100, the translator 101, the status manager 102, the compaction unit 103, the write and erase unit 104, the read unit 105, the timing generation unit 106, and the patrol unit 107 may be realized by hardware, or by a combination of hardware and software. Some of or all of the command processor 100, the translator 101, the status manager 102, the compaction unit 103, the write and erase unit 104, the read unit 105, the timing generation unit 106, and the patrol unit 107 may be configured by using ASIC. Further, the memory controller 10 includes a register inside or outside itself, and may store the page record table 108 and the shift amount record table 109 in the register.

The command processor 100 receives commands from the host 2. The write command from the host 2 at least includes data (write data) and a logical address. The read command from the host 2 at least includes a logical address. The command processor 100 causes the translator 101 to translate the logical address included in the command from the host 2 to a physical address. The command processor 100 causes the write and erase unit 104 to perform writing of the write data, and cause the read unit 105 to perform reading of read data according to the command from the host 2. The command processor 100 sends the physical address acquired from the translator 101 to the write and erase unit 104 or the read unit 105 as information designating an access destination.

The write and erase unit 104 causes writing to be performed on a memory chip 21 by issuing the write command to the memory chip 21. The write command includes a physical address and write data. Here, the write and erase unit 104 performs encoding of the write data for error detection and error correction. A scheme of the encoding is not limited to a specific scheme.

Further, the write and erase unit 104 causes erasing to be performed on the memory chip 21 by issuing an erase command to the memory chip 21. The erase command includes a physical address of a block. The erasing is performed as a part of compaction.

The read unit 105 causes reading to be performed on the memory chip 21 by issuing a read command to the memory chip 21. The read command at least includes a physical address. The read unit 105 can perform the error detection and error correction on the read data by performing decoding of the read data outputted from the memory chip 21. If the error correction fails, the read unit 105 can shift a read voltage for the memory chip 21 and perform the reading of the read data again. If the error correction succeeds, the read unit 105 can record the shift amount upon the success of the error correction in the shift amount record table 109 in an overwriting manner. In performing the reading of the read data again from a position where the reading has once been carried out, the read unit 105 uses the read voltage to which the shift amount recorded in the shift amount record table 109 is applied.

As an example, the shift amount record table 109 records the shift amount for each block. That is, the memory system 1 herein is configured capable of changing the read voltage for each block. Notably, the memory system 1 may be configured capable of changing the read voltage in units different from blocks (for example, in units of memory chips 21). The shift amount record table 109 records the shift amount in units by which the read voltage can be changed.

Further, the read unit 105 causes the read voltage to be shifted by issuing a read voltage setting command to the memory chip 21. The read voltage setting command at least includes the shift amount. In the memory chip 21, the access controller 22 can calculate the read voltage to be used in reading by adding the shift amount included in the read voltage setting command to the initial value of the read voltage stored in the read voltage storage 23.

Notably, description will be given herein as that the memory chip 21 is caused to retain the initial value of the read voltage, and the memory controller 10 designates the shift amount with the initial value as the reference, however, the memory controller 10 may be configured capable of designating the read voltage itself.

The status manager 102 manages states of the blocks that the NAND memory 20 has. The states of the blocks include for example a “data writing” state, a “data written” state, an “erased” state, and the like. The “data writing” state is a state in of having both a page to which the write data has already been written (written page) and a page to which the write data has not yet been written (empty page). The “data written” state is a state of not having any empty page. The “erased” state is a state of not having any written page. The status manager 102 sends a notification designating a write destination block to the translator 101 upon writing. If there are not much writable blocks left, the status manager 102 causes the compaction unit 103 to perform compaction. Further, the compaction unit 103 is caused to perform the compaction based on a request from the patrol unit 107.

The compaction unit 103 performs the compaction. The compaction is a process of copying valid data stored in one block in the “data written” state or the “data writing” state to another block, and thereafter erasing all of data stored in the one block. The compaction is performed with a purpose of generating blocks in the “erased” state, and refreshing the data. The compaction unit 103 performs copy and erase by controlling the write and erase unit 104 and the read unit 105.

Notably, the block on which the compaction is performed transitions to the “erased” state. The status manager 102 resets the shift amount of the read voltage for the block having transitioned to the “erased” state to a zero value by updating the shift amount record table 109.

Upon writing, the translator 101 associates the physical address of the empty page within the block notified from the status manager 102 with the logical address included in the write command, and sends the same to the command processor 100. Further, upon reading, the translator 101 calculates the physical address associated with the logical address included in the read command and sends the same to the command processor 100.

The patrol unit 107 performs various patrols. The patrols that the patrol unit 107 performs include a shift adjustment patrol, a refresh patrol, a first detection patrol, and a second detection patrol. The patrol unit 107 controls the write and erase unit 104 and the read unit 105 upon performing the various patrols.

The shift adjustment patrol is a process that sequentially focuses on each block, and adjusts the read voltage of the focused block. The patrol unit 107 records the shift amount from the initial value of the read voltage after the adjustment in the shift amount record table 109.

The refresh patrol is a process that sequentially focuses on each block, and determines whether the focused block is a refreshing target or not. A block having a page with data to be stored being unstable is determined as the refreshing target. Specifically, the read voltage has a limit to its shiftable amount. A block having a page of which minimum shift amount required for succeeding in the error correction exceeds a predetermined threshold (first threshold) that is less than the limit is set as the refreshing target so that the error correction does not occur even when the read voltage is shifted to the limit.

Here, as an example, a block in which a page of which error correction is impossible even when the shift amount is changed to the first threshold is set as the refreshing target. Notably, a block having a page of which capacity in the error correction performance is insufficient despite having shifted the read voltage to the limit may be set as the refreshing target. Specifically, an error correction number is counted by performing reading by a voluntary predetermined shift amount (including the shift amount of the limit) that is larger than the first threshold, and a block having a page of which error correction number exceeds a predetermined value that is set according to the shift amount may be set as the refreshing target. Further, a block having a page of which capacity in the error correction performance is insufficient despite having shifted the read voltage to the limit may be set as the refreshing target.

The first detection patrol is a process that sequentially focuses on each block, and selects one page that is to be a reference of a level adjustment in the shift adjustment patrol for each block, from the focused block. The page selected by the first detection patrol will be described as a normal page.

The second detection patrol is a process that sequentially focuses on each block, and selects one page to be used for the determination in the refresh patrol from the focused block. In the second detection patrol, the pages configuring the focused block is read, and a page with the largest minimum shift amount required for succeeding in the error correction is selected in the focused block. Here, as an example, a page with the largest error detection number is selected among the pages with the largest shift amount. This is because if the shift amount is identical, the minimum shift amount required for succeeding in the error correction would be smaller for less error detection number. The page selected by the second detection patrol will be described as a dangerous page.

The patrol unit 107 records the dangerous page and the normal page in the page record table 108. The patrol unit 107 references the page record table 108 upon performing the refresh patrol and the shift adjustment patrol.

Notably, although one page is selected for each block in the first detection patrol and the second detection patrol, two or more pages may be selected for each block in the first detection patrol or the second detection patrol.

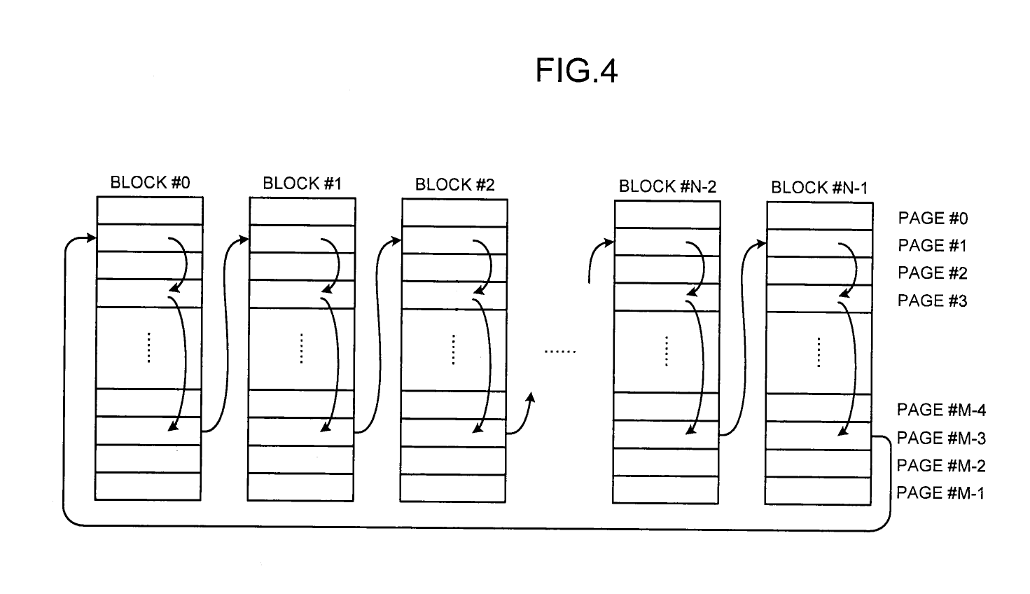

FIG. 4 is a diagram for describing pages to be read by a first detection patrol. In FIG. 4, the NAND memory 20 includes N pieces of blocks, and each block includes M pieces of pages. Each block is distinguished from one another by a block number of #0 to #N−1. Further, each page is distinguished from one another by a page number of #0 to #M−1. Further, for a purpose of speeding up a detection speed, a part of plurality of pages among the pages configuring the focused block is herein set as sample pages, and the plurality of sample pages is sequentially read. Among the plurality of normal pages, one sample page with an error bit rate that is closest to a median is selected as the normal page. In the example of FIG. 4, three sample pages are set for each block. When reading is completed for all of normal pages of one block, the reading of the next page is performed.

Notably, a method of selecting the normal page is not limited to the above. For example, one sample page with the error bit rate that is closest to an average may be selected as the normal page.

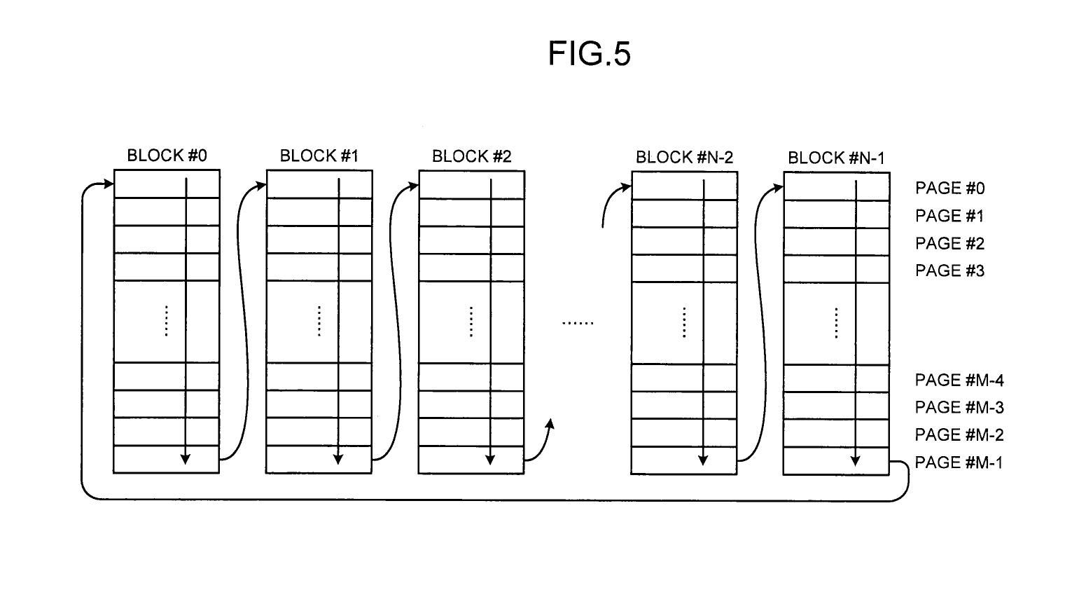

FIG. 5 is a diagram for describing pages to be read by a second detection patrol. In the second detection patrol, all of pages configuring the focused block are read sequentially. Reading of a subsequent block is performed after having completed the reading of all pages for one block.

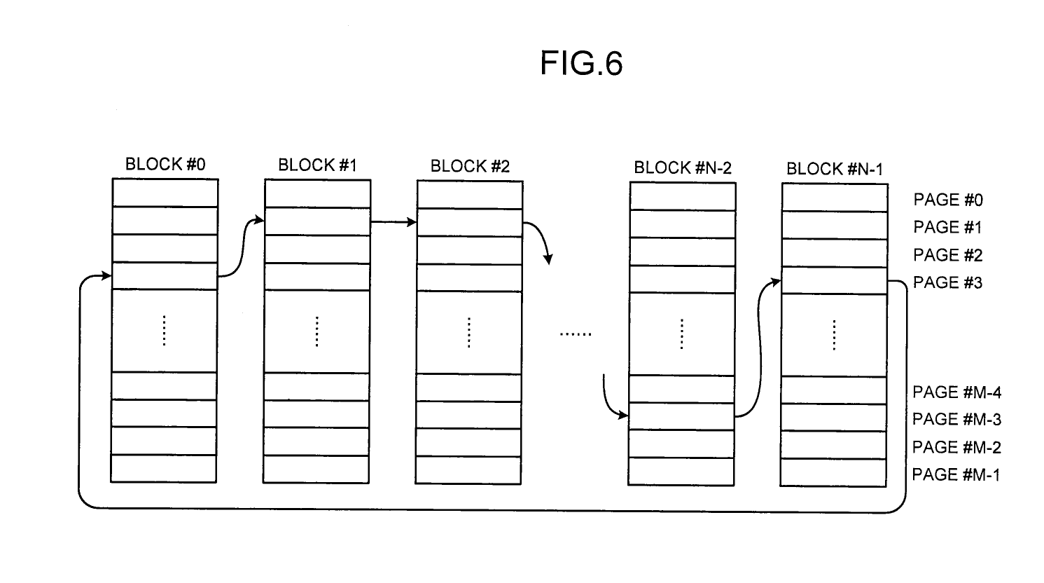

FIG. 6 is a diagram for describing pages to be read by a shift adjustment patrol. Upon the shift adjustment patrol, since only the normal page selected by the first detection patrol is read, the shift adjustment patrol is sped up compared to a case of reading all pages configuring the focused block.

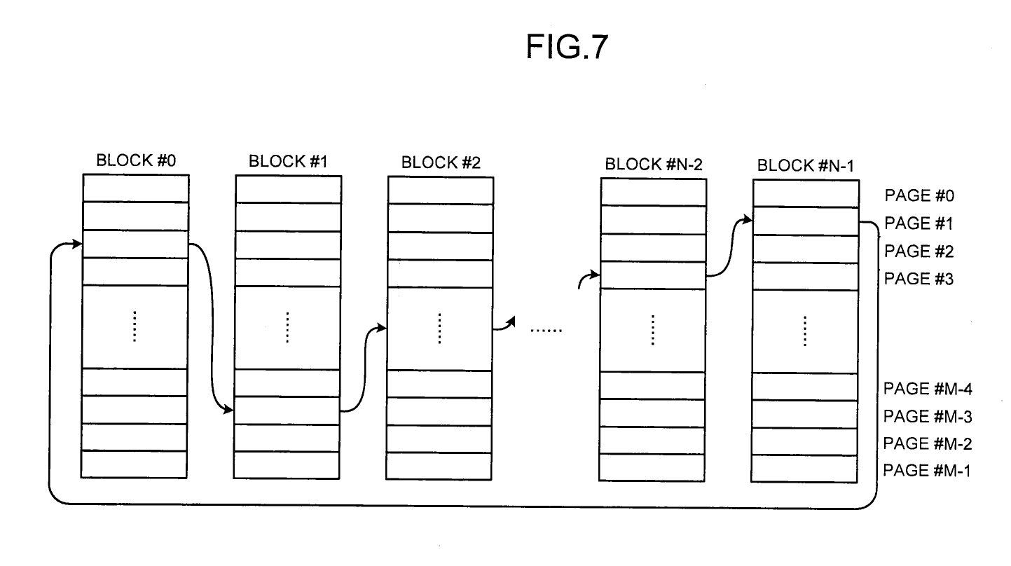

FIG. 7 is a diagram for describing pages to be read by a refresh patrol. Upon the refresh patrol, since only the dangerous page selected by the second detection patrol is read, the refresh patrol is sped up compared to a case of reading all pages configuring the focused block.

Each patrol requires activation by the timing generation unit 106 each time the patrol proceeds by one page. A process for one page configuring the patrol is described as a unit process. The timing generation unit 106 prompts the patrol unit 107 to activate a patrol every predetermined time period.

The patrol unit 107 has an execution schedule of each patrol so that the various patrols are performed respectively at different frequencies.

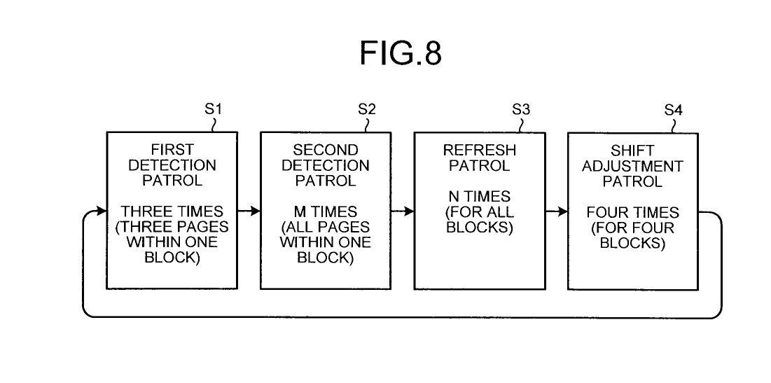

FIG. 8 is a diagram for describing an execution schedule of the patrols. As illustrated, firstly, the unit process of the first detection patrol is performed for one block (S1). Since three pages of sample pages are set in each block, the unit process of the first detection patrol is activated three times in row. Next, the unit process of the second detection patrol is performed on one block (S2). According to the second detection patrol, since all of the pages are read for each block, the unit process of the second detection patrol is activated M times in row. Next, the unit process of the refresh patrol is performed for all of the blocks (S3). That is, the unit process of the refresh patrol is activated N times in row. Next, the unit process of the shift adjustment patrol is performed for a predetermined number (which is herein four) of blocks (S4). That is, the unit process of the shift adjustment patrol is activated four times in row. After the process of step S4, the process of step S1 is performed.

Accordingly, since the frequency of the first detection patrol is made less than the frequency of the shift adjustment patrol, a decrease in performances of the memory system 1 caused by the patrols can be suppressed. Further, since the frequency of the second detection patrol is made less than the frequency of the refresh patrol, the decrease in performance of the memory system 1 caused by the patrols can be suppressed.

Notably, a focusing range of each patrol may be limited only to blocks in a voluntary state. For example, the shift adjustment patrol is performed by a block in the “data writing” state or the “data written” state being focused.

Next, the unit processes of each patrol will be described in detail. Notably, the patrol unit 107 stores a process target position for each type of patrol. The process target position is the block being focused (target block), or a page under process (target page), or a combination thereof. Further, the patrol unit 107 stores a patrol that is a target to be performed (target patrol) among the first detection patrol, the second detection patrol, the refresh patrol, and the shift adjustment patrol. When the activation of a patrol is prompted, the patrol unit 107 performs the type of patrol stored as the target patrol on the target position.

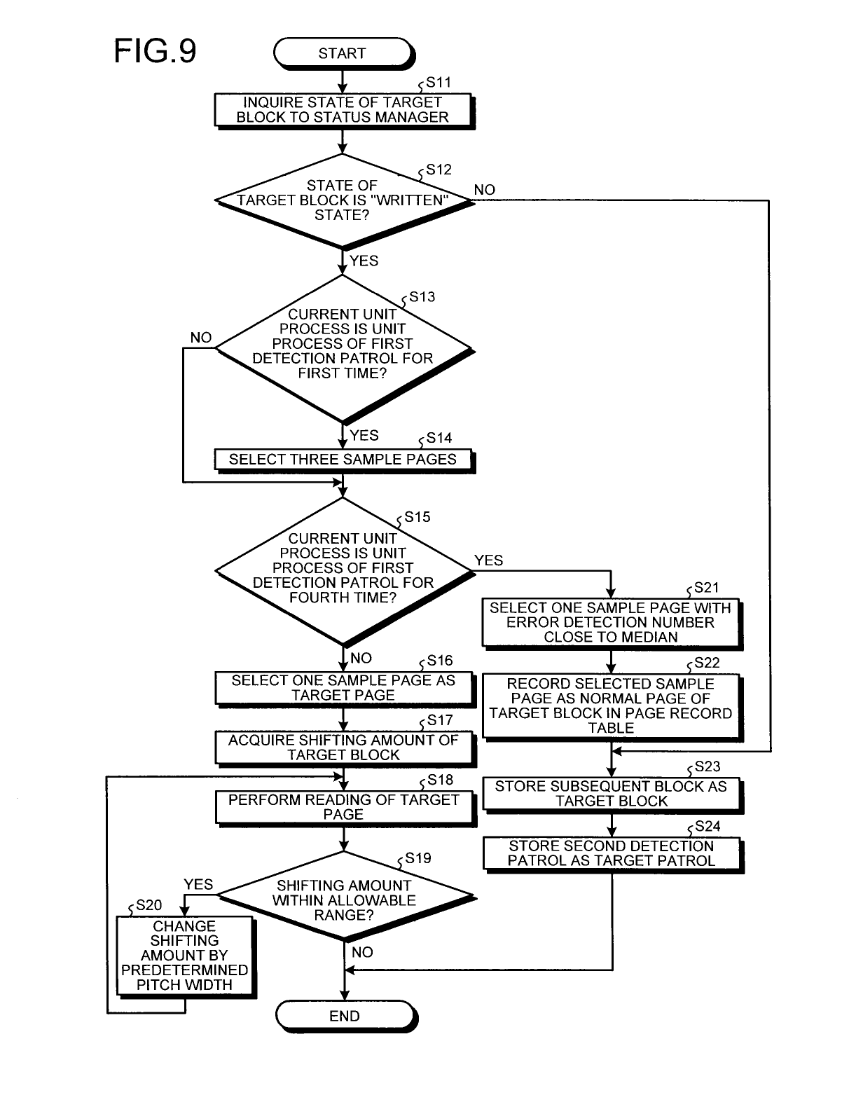

FIG. 9 is a flow chart describing unit processing of the first detection patrol.

Firstly, the patrol unit 107 inquires the status manager 102 of the state of the target block (S11). The patrol unit 107 determines whether the state of the target block is the “data written” state or not (S12). In a case where the state of the target block is not in the “data written” state (S12, No), the patrol unit 107 performs a process of step S23 to be described later.

In a case where the state of the target block is the “data written” state (S12, Yes), the patrol unit 107 determines whether the unit process of the first detection patrol that is currently being performed is a unit process of the first detection patrol performed for the first time on the target block or not (S13). In a case where the unit process of the first detection patrol that is currently being performed is a unit process of the first detection patrol performed for the first time on the target block (S13, Yes), the patrol unit 107 selects three sample pages, and memorizes them (S14). Notably, a method by which the patrol unit 107 selects the three sample pages is voluntary. Page numbers of the three sample pages may be set unchangeably in advance. In a case where the unit process of the first detection patrol that is currently being performed is not a unit process of the first detection patrol performed for the first time on the target block (S13, No), the process of step S14 is skipped.

Subsequently, the patrol unit 107 determines whether the unit process of the first detection patrol that is currently being performed is a unit process of the first detection patrol performed for the fourth time on the target block or not (S15). In a case where the unit process of the first detection patrol that is currently being performed is not a unit process of the first detection patrol performed for the fourth time on the target block (S15, No), the patrol unit 107 selects one sample page on which the unit process of the first detection patrol has not yet been performed as the target page (S16). The patrol unit 107 refers to the shift amount record table 109, and acquires the shift amount for the target block (S17). The patrol unit 107 causes the read unit 105 to perform reading of the target page, and to report the error detection number (S18). Notably, in the process of step S18, the reading is performed by using the shift amount acquired by the process of step S17. The patrol unit 107 stores the shift amount and the reported error detection number in association with the target page. Further, the patrol unit 107 determines whether the shift amount is within an allowable range or not (S19). In a case where the shift amount is within the allowable range (S19, Yes), the patrol unit 107 changes the shift amount at a predetermined pitch width (for example, +100 mV) (S20), and performs the process of step S18 again. In a case where the shift amount is outside the allowable range (S19, No), the patrol unit 107 ends the unit process of the first detection patrol.

When the unit process of the first detection patrol that is currently being performed is the unit process of the first detection patrol on the target block for the fourth time (S15, Yes), the patrol unit 107 selects one sample page with the error detection number of the three sample pages being close to the median by referencing the error detection number for each shift amount (S21). Notably, how the sample page is selected in the process of step S21 is voluntary. For example, the patrol unit 107 selects one shift amount, and selects a sample page with which the error detection number of each sample page upon being read by using the selected shift amount is close to the median. The patrol unit 107 records the selected sample page as the normal page of the target block in the page record table 108 (S22). Then, the patrol unit 107 stores the next block as the target block in the overwriting manner (S23), stores the second detection patrol as the target patrol in the overwriting manner (S24), and ends the unit process of the first detection patrol. A unit process of the second detection patrol is performed next time the patrol is activated.

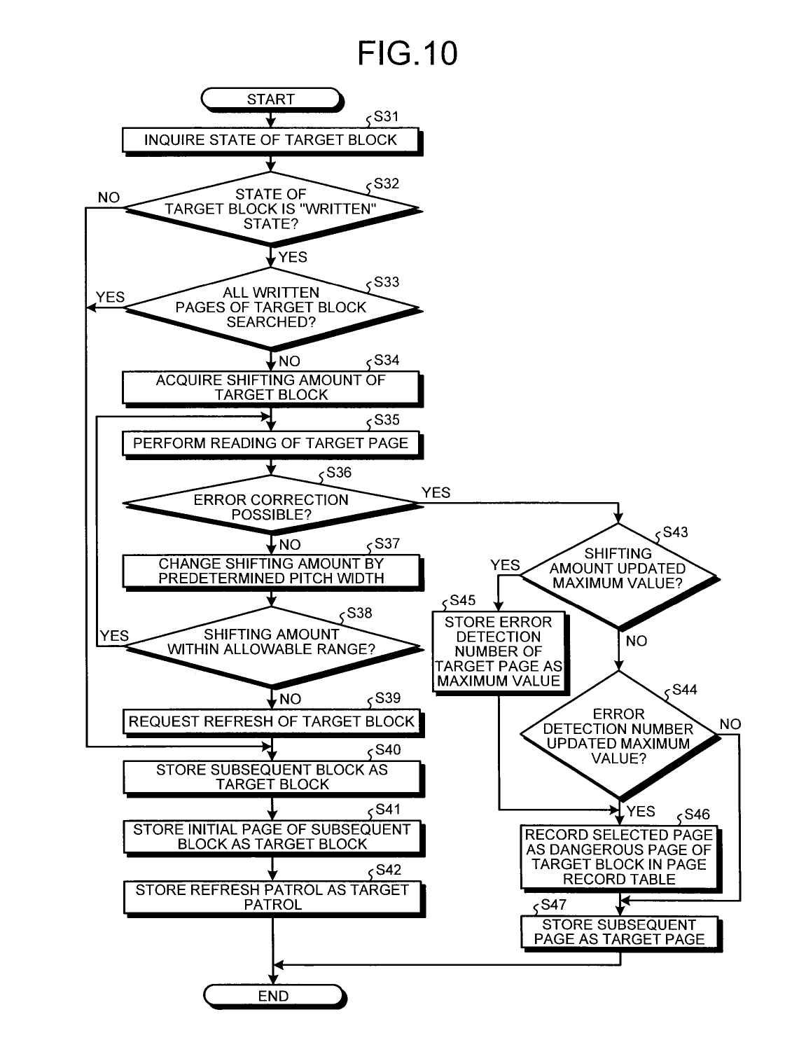

FIG. 10 is a flow chart describing the unit processing of the second detection patrol.

Firstly, the patrol unit 107 inquires the state of the target block to the status manager 102 (S31). The patrol unit 107 determines whether the state of the target block is the “data written” state or not (S32). In a case where the state of the target block is in the “data written” state (S32, Yes), the patrol unit 107 determines whether all of the written pages in the target block have been searched or not (S33). In a case where the state of the target block is not in the “data written” state (S32, No), or in a case where all of the written pages in the target block have been searched (S33, Yes), the patrol unit 107 performs the process of step S40 to be described later.

In a case where there is a written page that has not yet been searched (S33, No), the patrol unit 107 refers to the shift amount record table 109 and acquires the shift amount of the target block (S34). Then, the patrol unit 107 causes the read unit 105 to perform reading of the target page, and have the read unit 105 report the error detection number and whether the error correction can be performed or not (S35). In a case where the error correction cannot be performed (S36, No), the patrol unit 107 changes the shift amount by a predetermined pitch width (S37), and determines whether the shift amount after the change is within the allowable range or not (S38). In a case where the shift amount after the change is within the allowable range (S38, Yes), the patrol unit 107 performs the process of step S35 again.

In a case where the shift amount after the change is out of the allowable range (S38, No), the patrol unit 107 requests the status manager 102 to refresh the target block (S39). The status manager 102 to which the refresh has been requested refreshes the data stored in the target block by causing the compaction unit 103 to perform compaction.

Next, the patrol unit 107 stores a subsequent block as the target block in the overwriting manner (S40), and stores the initial page of the subsequent block as the target page in the overwriting manner (S41). Then, the patrol unit 107 stores the refresh patrol as the target patrol in the overwriting manner (S42), and ends the unit processing of the second detection patrol.

In a case where the error correction can be performed (S36, Yes), the patrol unit 107 determines whether the shift amount has updated a maximum value since when the unit processing of the second detection patrol is performed on the target block or not (S43). In a case where the shift amount has not updated the maximum value (S43, No), the patrol unit 107 determines whether the error detection number has updated a maximum value since when the unit processing of the second detection patrol is performed on the target block or not (S44). In a case where the shift amount has updated the maximum value (S43, Yes) the patrol unit 107 stores the error detection number of the target page as the maximum value (S45). After the process of step S45 or in the case where the error detection number updated the maximum value (S44, Yes), the patrol unit 107 records the target page as the dangerous page of the target block in the page record table 108 (S46). After the process of step S46, or in a case where the error detection number has not updated the maximum value (S44, No), the patrol unit 107 stores a subsequent page as the target page in the overwriting manner (S47), and ends the unit processing of the second detection patrol. Notably, in a case where the page on which the unit processing of the second detection patrol is being performed is page #M−1, the patrol unit 107 stores a subsequent block as the target block in the overwriting manner in the process of step S46, and stores the page #0 of the subsequent block as the target pages in the overwriting manner.

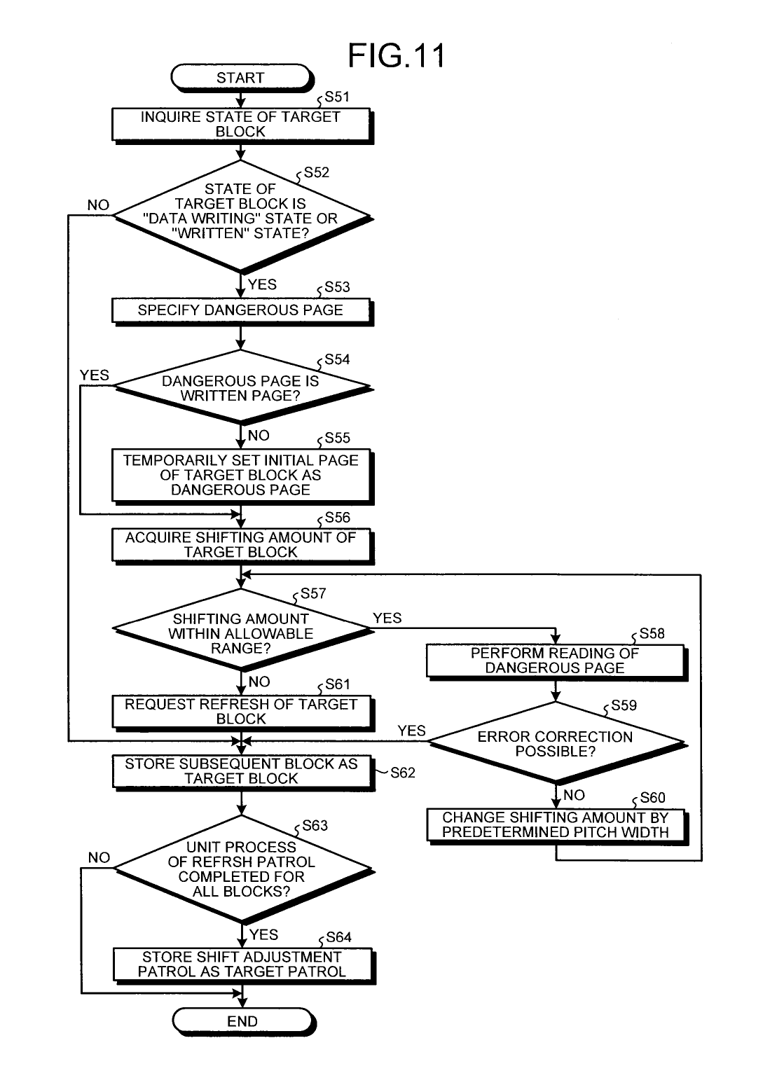

FIG. 11 is a flow chart describing unit processing of the refresh patrol.

Firstly, the patrol unit 107 inquires the status manager 102 of the state of the target block (S51). The patrol unit 107 determines whether the state of the target block is the “data writing” state or the “data written” state (S52). In a case where the state of the target block is neither in the “data writing” state nor the “data written” state (S52, No), the patrol unit 107 performs a process of step S63 to be described later.

In a case where the state of the target block is in the “data writing” state or the “data written” state (S52, Yes), the patrol unit 107 specifies a dangerous page by referring to the page record table 108, and memorizes it (S53). The patrol unit 107 determines whether the dangerous page is a written page or not (S54). In a case where the dangerous page is not a written page (S54, No), the patrol unit 107 temporarily sets an initial page of the target block as a dangerous page (S55). In the oncoming processes, the initial page will be dealt as the dangerous page, however, overwriting of the page record table 108 is not performed in the process of step S55. In a case where the dangerous page is a written page (S54, Yes), the patrol unit 107 skips the process of step S55.

Subsequently, the patrol unit 107 refers to the shift amount record table 109, and acquires the shift amount for the target block (S56). The patrol unit 107 determines whether the shift amount is within an allowable range or not (S57). In a case where the shift amount is within the allowable range (S57, Yes), the patrol unit 107 causes the read unit 105 to perform reading of the target page, and have the read unit 105 report the error detection number and whether the error correction can be performed or not (S58). In a case where the error correction is impossible (S59, No) the patrol unit 107 changes the shift amount by a predetermined pitch width (S60), and the process of step S57 is performed again. In a case where the error correction is possible (S59, Yes), the patrol unit 107 performs the process of S62 described later.

In a case where the shift amount is out of the allowable range (S57, No), the patrol unit 107 requests the status manager 102 to refresh the target block (S61). The patrol unit 107 stores a subsequent block as the target block in the overwriting manner (S62). The patrol unit 107 determines whether the unit processing of the refresh patrol has been completed for all of the blocks or not (S63). In a case where the unit processing of the refresh patrol has been completed for all of the blocks (S63, Yes), the patrol unit 107 stores the shift adjustment patrol as the target patrol in the overwriting manner (S64), and ends the unit processing of the refresh patrol. In a case where the unit processing of the refresh patrol has not been completed for all of the blocks (S63, No), the patrol unit 107 skips the process of step S64.

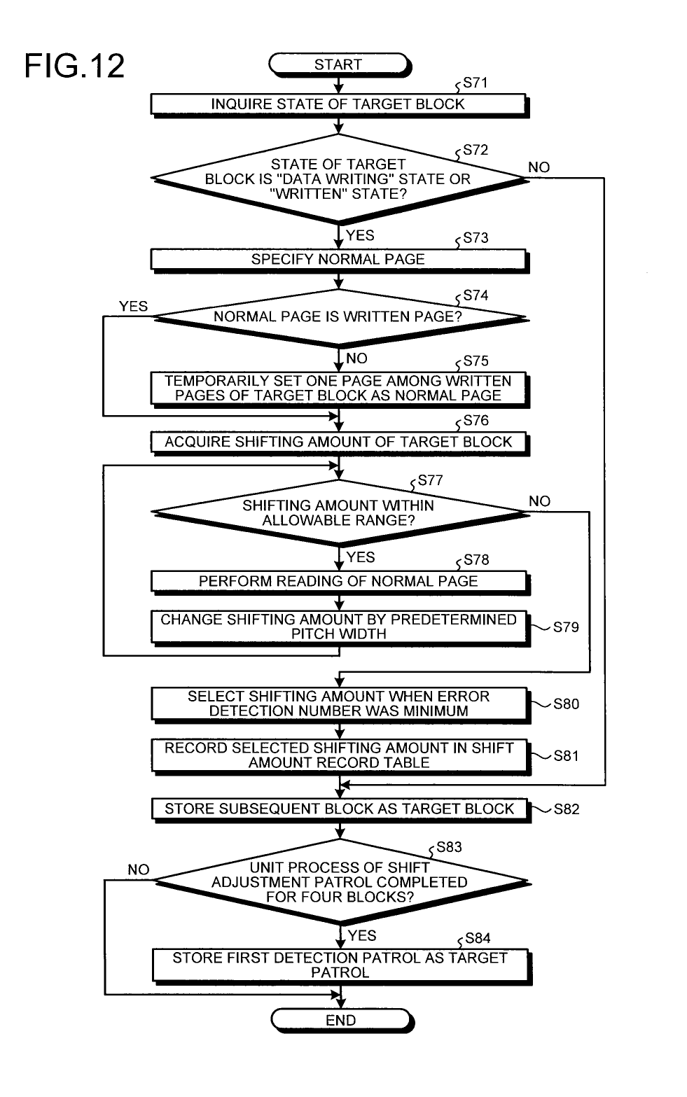

FIG. 12 is a flow chart describing unit processing of the shift adjustment patrol.

Firstly, the patrol unit 107 inquires the status manager 102 of the state of the target block (S71). The patrol unit 107 determines whether the state of the target block is the “data writing” state or the “data written” state (S72). In a case where the state of the target block is neither in the “data writing” state nor the “data written” state (S72, No), the patrol unit 107 performs a process of step S82 to be described later.

In a case where the state of the target block is in the “data writing” state or the “data written” state (S72, Yes), the patrol unit 107 specifies a normal page by referring to the page record table 108, and memorizes it (S73). The patrol unit 107 determines whether the normal page is a written page or not (S74). In a case where the normal page is not a written page (S74, No), the patrol unit 107 selects one page from among the written pages in the target blocks, and temporarily sets the selected page as the normal page (S75). In the oncoming processes, the selected page will be dealt as the normal page, however, overwriting of the page record table 108 is not performed in the process of step S75. A method of selecting the normal page is not specifically limited. For example, a page close to a median among the written pages is selected as the normal page. In a case where the normal page is a written page (S74, Yes) the patrol unit 107 skips the process of step S75.

Subsequently, the patrol unit 107 refers to the shift amount record table 109, and acquires the shift amount for the target block (S76). The patrol unit 107 determines whether the shift amount is within an allowable range or not (S77). In a case where the shift amount is within the allowable range (S77, Yes), the patrol unit 107 causes the read unit 105 to perform reading of the normal page, and have the read unit 105 report the error detection number (S78). The patrol unit 107 stores the shift amount and the reported error detection number in association. The patrol unit 107 changes the shift amount by a predetermined pitch width (S79), and the process of step S77 is performed again.

In a case where the shift amount is out of the allowable range (S77, No), the patrol unit 107 selects the shift amount by which the error detection number was minimum among the stored shift amounts (S80). The patrol unit 107 records the selected shift amount in the shift amount record table 109. The patrol unit 107 stores a subsequent block as the target block in the overwriting manner (S82). The patrol unit 107 determines whether the unit processing of the shift adjustment patrol has been completed for four pieces of blocks or not (S83). In a case where the unit processing of the s shift adjustment patrol has been completed for the four pieces of blocks (S83, Yes), the patrol unit 107 stores the first detection patrol as the target patrol in the overwriting manner (S84), and ends the unit processing of the shift adjustment patrol. In a case where the unit processing of the shift adjustment patrol has not been completed for the four pieces of blocks (S83, No), the patrol unit 107 skips the process of step S84.

As above, according to the first embodiment of the invention, the memory controller 10 detects the dangerous pages with the stored data being unstable for each block by reading the data stored in each of the plurality of pages while performing the error detection. Further, the memory controller 10 detects the pages in which the error in the read data has increased and a capacity of the shift read amount is being insufficient by reading the data stored in the dangerous pages while shifting the read voltage in the predetermined range, and also while performing the error correction on the read data. Further, the memory controller 10 refreshes the data stored in the block having the page in which the error in the read data has increased and the capacity of the shift read amount is being insufficient. Due to this, the refresh patrol is performed at high speed.

Further, the memory controller 10 detects the page with the maximum shift amount of the read voltage or error detection number upon when the error correction of the read data was successfully performed in each block as the dangerous page. Due to this, the data stored in the respective blocks are prevented from becoming incapable of the error correction.

Further, the memory controller 10 reads the data stored respectively in the plurality of pages while performing the error detection, and detects the normal pages for each block based on the error detection number. Moreover, the memory controller 10 calculates the shift amount with the minimum error detection number for each block by reading the data stored in the normal pages in each block while shifting the read voltage and while performing the error detection of the read data. Moreover, the memory controller 10 stores the shift amount calculated for each block in association with the block, and upon reading, reads the read data by using the shift amount corresponding to the block to which the page where the read target data is stored belongs. Due to this, since the memory system 1 can obtain the optimal shift amount while suppressing decrease in performances, whereby the reading performance of the memory system 1 is improved.

Further, the memory controller 10 detects the normal page from the sample pages within the plurality of pages. Due to this, the process for calculating the optimal shift amount can be sped up.

### Second Embodiment

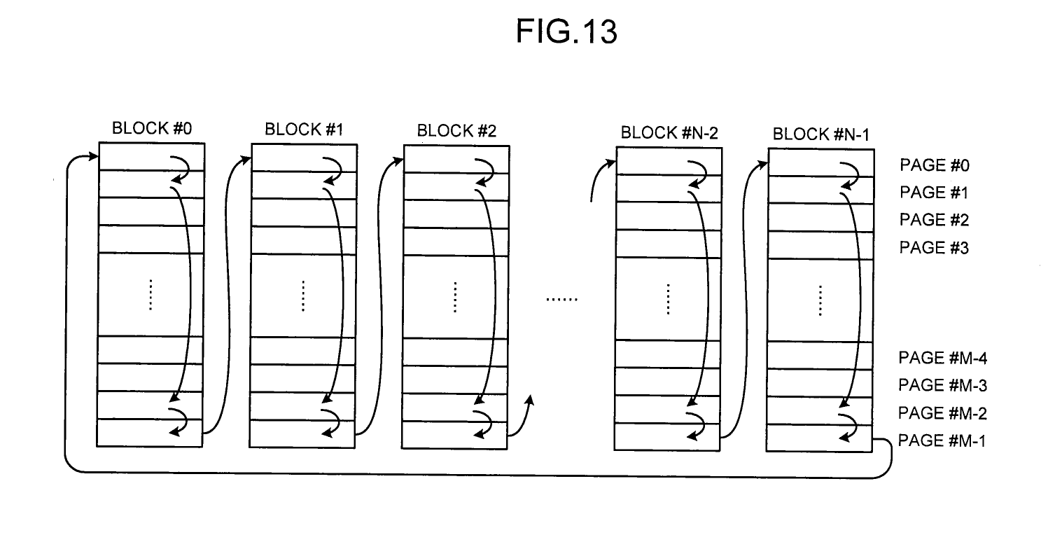

FIG. 13 is a diagram for describing pages to be read by a second detection patrol of a second embodiment. In the second detection patrol of the second embodiment, only a part of pages with a tendency that bit error rate becomes high is read sequentially among a plurality of pages configuring a focused block.

The page scheduled to be read is specified in advance, and is stored in a patrol unit 107. For example, among word lines configuring a memory cell array 24, the tendency that bit error rate becomes high is exhibited in word lines positioned on a drain side due to a phenomenon called gate-induced drain leakage. For example, one or more pages closest to the drain side are read. In the example of FIG. 13, a page #0, a page #1, a page #M−2, and a page #M−1 are scheduled to be read. Notably, the page scheduled to be read will be expressed as a scheduled page.

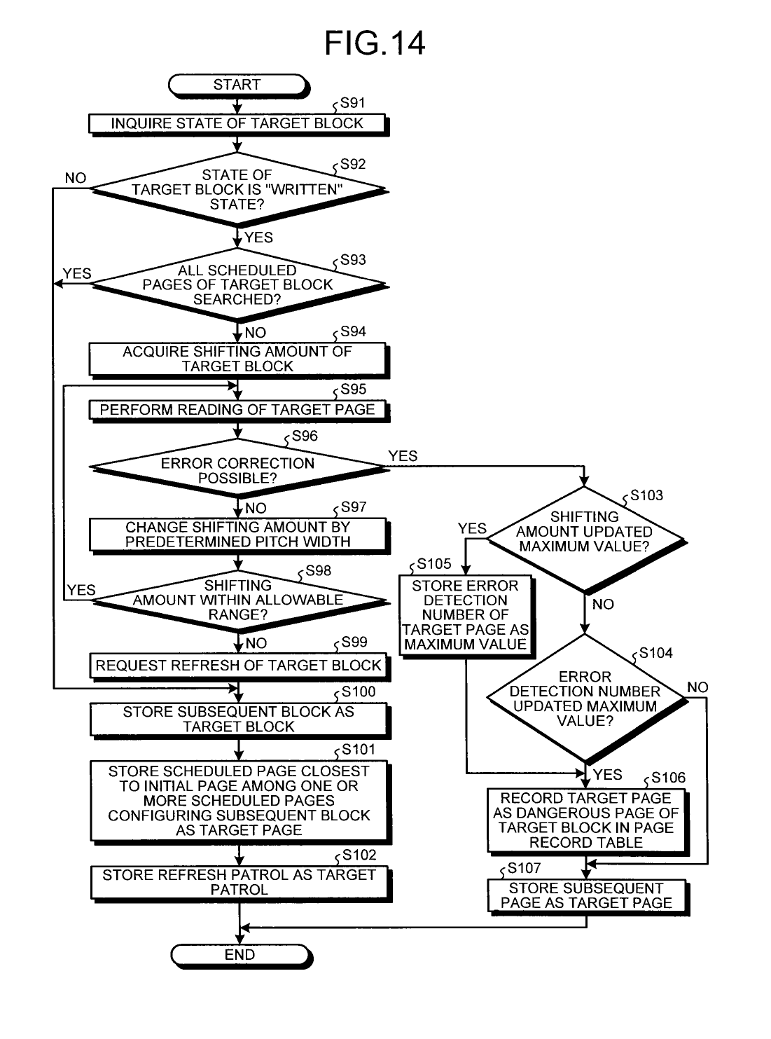

FIG. 14 is a flow chart describing unit processing of a second detection patrol of the second embodiment. Processes of steps S91, S92, S94 to S100 are identical to steps S31, S32, S34 to S40. Further, processes of steps S102 to S106 are identical to steps S42 to S46. In step S93, the patrol unit 107 determines whether all of scheduled pages of the target block have been searched or not (S93). Further, in step S101, the patrol unit 107 stores the scheduled page that is closest to an initial page among one or more scheduled pages configuring a subsequent block as the target page in the overwriting manner (S101). Further, in step S107, the patrol unit 107 stores a subsequent scheduled page as the target page in the overwriting manner (S107). Notably, in a case where the page on which the unit processing of the second detection patrol is being performed is the last page among the one or more scheduled pages configuring the target block, the patrol unit 107 stores the subsequent block as the target block in the overwriting manner in the process of step S107, and stores the scheduled page closest to the initial page among the one or more scheduled pages configuring the subsequent block as the target block in the overwriting manner.

As above, according to the second embodiment, the memory controller 10 detects the dangerous pages from a part of the pages among the plurality of pages. Due to this, it becomes possible to detect the blocks that are the targets of refreshing at a faster speed.

Further, the page to be read by the second detection patrol is limited to a part of pages positioned on the most drain side within the memory cell array 24. Due to this, the dangerous pages can efficiently be detected.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
nonvolatile memory including a plurality of blocks, each of which includes a plurality of pages; and
a memory controller configured to control the nonvolatile memory,
wherein the memory controller is configured to
detect a first page of which a required minimum shift amount of a read voltage is largest for each block by reading data stored in each of the plurality of pages while performing error detection,
detect a second page of which the required minimum shift amount of a read voltage is larger than a predetermined first threshold by reading data stored in the first page of each of the blocks while shifting the read voltage and performing error detection, and
refresh data stored in a block having the second page.

2. The memory system according to claim 1, wherein
the memory controller is configured to
read the data stored in each of the plurality of pages while shifting the read voltage and performing error correction of the read data, and
detect the first page based on a shift amount of the read voltage or an error detection number upon when the error correction of the read data succeeds.

3. The memory system according to claim 2, wherein
the memory controller is configured to
detect a page with a largest error correction number as the first page among pages of which the shift amount of the read voltage is largest among the plurality of pages in the respective blocks.

4. The memory system according to claim 1, wherein
the memory controller is configured to
detect a first page of which error correction fails upon reading while shifting the read voltage by an amount of the first threshold among the first pages of the respective blocks.

5. The memory system according to claim 1, wherein
the memory controller is configured to
detect a first page of which error correction number exceeds a predetermined value upon reading while shifting the read voltage by an amount of a predetermined second threshold that is larger than the first threshold as the second page among the first pages of the respective blocks as the second page.

6. The memory system according to claim 1, wherein
the memory controller is configured to detect the first page from among a predetermined group of pages in the plurality of pages.

7. The memory system according to claim 6, wherein
each of the blocks is configured of a memory cell array, and
the predetermined group of pages is a group of pages positioned on a most drain side in the memory cell array.

8. A memory controller configured to control nonvolatile memory, the nonvolatile memory including a plurality of blocks, each of which includes a plurality of pages,
the memory controller being configured to:
detect a first page of which a required minimum shift amount of a read voltage is largest for each block by reading data stored in each of the plurality of pages while performing error detection,
detect a second page of which the required minimum shift amount of a read voltage is larger than a predetermined first threshold by reading data stored in the first page of each of the blocks while shifting the read voltage and performing error detection, and
refresh data stored in a block having the second page.

9. The memory controller according to claim 8, being configured to:
read the data stored in each of the plurality of pages while shifting the read voltage and performing error correction of the read data, and
detect the first page based on a shift amount of the read voltage or an error detection number upon when the error correction of the read data succeeds.

10. The memory controller according to claim 8, being configured to:
detect a page with a largest error correction number as the first page among pages of which the shift amount of the read voltage is largest among the plurality of pages in the respective blocks.

11. The memory controller according to claim 8, being configured to:
detect a first page of which error correction fails upon reading while shifting the read voltage by an amount of the first threshold among the first pages of the respective blocks.

12. The memory controller according to claim 8, being configured to:
detect a first page of which error correction number exceeds a predetermined value upon reading while shifting the read voltage by an amount of a predetermined second threshold that is larger than the first threshold as the second page among the first pages of the respective blocks as the second page.

13. The memory controller according to claim 8, being configured to:
detect the first page from among a predetermined group of pages in the plurality of pages.

14. The memory controller according to claim 13, wherein
each of the blocks is configured of a memory cell array, and
the predetermined group of pages is a group of pages positioned on a most drain side in the memory cell array.

15. A memory system comprising:
nonvolatile memory including a plurality of blocks, each of which includes a plurality of pages; and
a memory controller configured to control the nonvolatile memory,
wherein the memory controller is configured to
read data stored in each of the plurality of pages while performing error detection, and detect a first page for each block based on an error detection number,
calculate a shift amount with a smallest error detection number for each block by reading data stored in the first page of each block while shifting the read voltage and performing error detection of the read data,
store the shift amount calculated for each block in association with a block, and
read data of a read target upon reading by using the shift amount corresponding to a block including a page in which data of the read target is stored.

16. The memory system according to claim 15, wherein
the memory controller is configured to detect the first page from among some pages in the plurality of pages.
